(19) United States
(12) Patent Application Publication
(10) Pub. No.: US 2021/0206068 A1
(43) Pub. Date: Jul. 8, 2021

(54) 3D PRINTER AND BUILD MODULE

(71) Applicant: HEWLETT-PACKARD DEVELOPMENT COMPANY, L.P., Spring, TX (US)

(72) Inventors: William E. HERTLING, Vancouver, WA (US); Benjiman WHITE, Vancouver, WA (US); Mike WHITMARSH, Vancouver, WA (US)

(73) Assignee: HEWLETT-PACKARD DEVELOPMENT COMPANY, L.P., Houston, TX (US)

(21) Appl. No.: 16/075,173

(22) PCT Filed: Apr. 20, 2017
(86) PCT No.: PCT/US2017/028589

§ 371 Date: Aug. 3, 2018

(51) Int. Cl. B29C 64/245; B29C 64/153; B33Y 30/00; B33Y 10/00; B33Y 50/02

(52) U.S. Cl. CPC B29C 64/245; B29C 64/153; B33Y 50/02; B33Y 10/00; B33Y 30/00

(57) ABSTRACT

According to one example, there is provided a method of operating a three-dimensional printer. The method comprises determining a size of a build chamber in which to generate a three-dimensional object, configuring a configurable build module to provide a build chamber of the determined size, and generating the three-dimensional object in the configured build chamber.

### BACKGROUND

Additive manufacturing, commonly referred to as three-dimensional or 3D printing, enables objects to be generated on a layer-by-layer basis, for example through the selective solidification of a build material.

Powder-based 3D printing systems, for example, typically form successive thin layers of a powder or particulate-type build material on a build platform and selectively solidify portions of each layer that represent a cross-section of a 3D object. Selective solidification techniques may include, for example, use of a printable fusing agent in combination with application of fusing energy to cause portions of the build material on which fusing agent is printed, or applied, to absorb more energy than portions of build material on which no fusing agent is printed. The portions on which fusing agent is printed melt and solidify to form part of the 3D object being printed, whereas non-fused build material remains in a generally non-solidified state and may be removed and, in some cases, reused in the generation of further 3D objects. Other 3D printing systems may use a laser to selectively sinter portions of a layer of build material.

### BRIEF DESCRIPTION

Examples will now be described, by way of non-limiting example only, with reference to the accompanying drawings, in which:

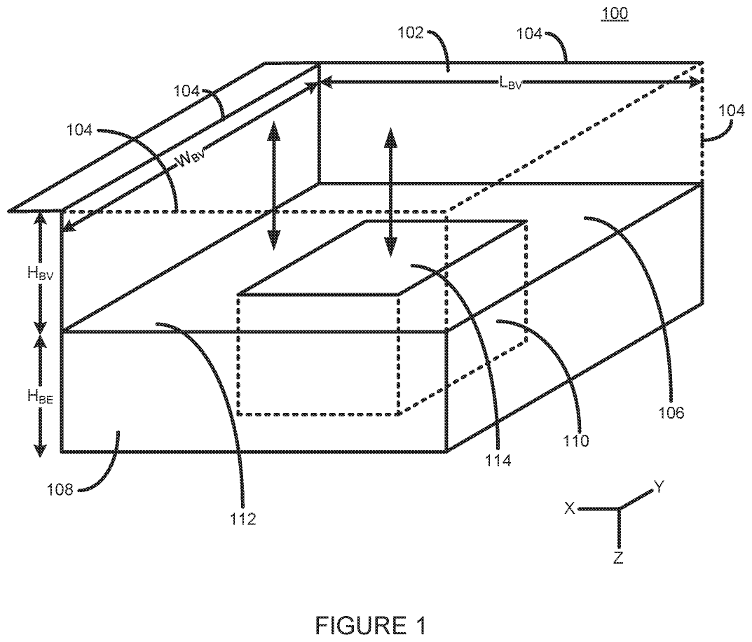

FIG. 1 is a simplified isometric view of a build module according to one example;

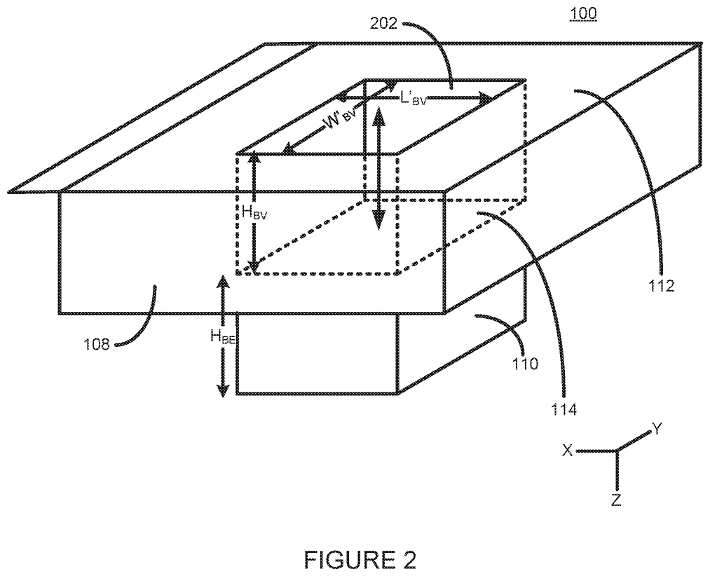

FIG. 2 is a simplified isometric view of a build module according to one example;

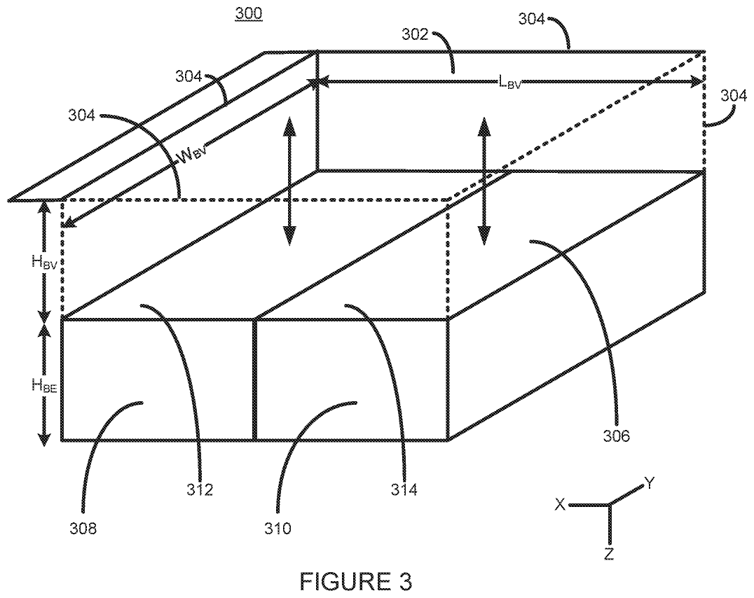

FIG. 3 is a simplified isometric view of a build module according to one example;

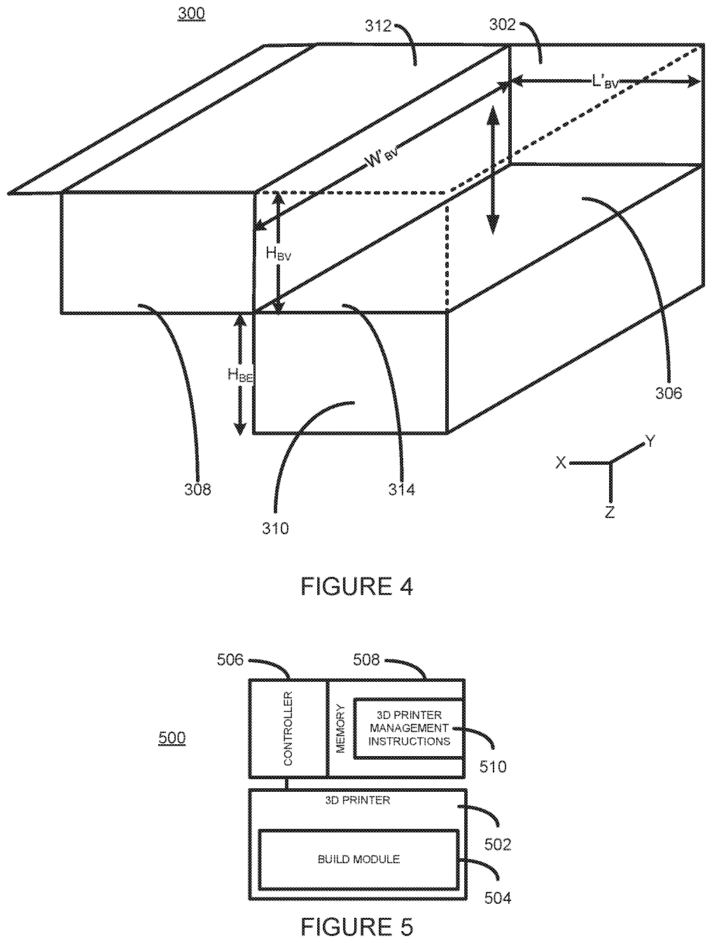

FIG. 4 is a simplified isometric view of a build module according to one example;

FIG. 5 is a schematic diagram of a 3D printing system according to one example; and

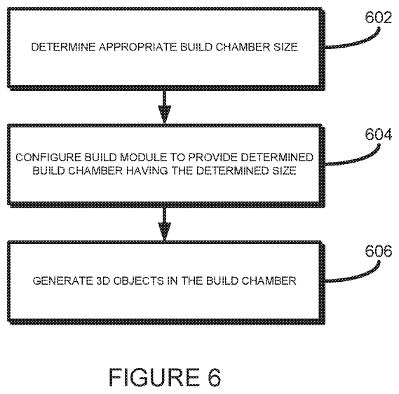

FIG. 6 is a flow diagram outlining an example method of operating a 3D printing system.

### DETAILED DESCRIPTION

Typically, powder-based 3D printing systems generate 3D objects in a build module in which is provided a build chamber. In some 3D printing systems the build module may be integrated into the 3D printing system, and in others the build module may be provided by a removable build unit.

A build chamber is a generally open-topped chamber in which a moveable build platform is provided. The build platform is moveable between a base position and an upper position along an axis that is perpendicular to the plane of the build platform. At the start of a 3D printing operation the build platform is positioned just below the top of the build chamber to allow a thin layer of build material to be formed on the build platform. The build material may be any suitable kind of 3D printing build material, such as powder or granulate type materials. Suitable materials may include many types of plastics, metals, and ceramics. The specific type of build material used may depend on the type of selective solidification process used by the 3D printing system. A layer of powder may be formed on the build platform, for example, by spreading with a roller or wiper a pile or volume of build material over the build platform. In some examples, the build module described herein may be suitable for use with liquid build materials, such as resins and polymerizable liquids.

The thickness of the layer of build material formed is largely dependent on the position of the build platform relative to the top of the build chamber. A selective solidification process may then be performed on the layer of build material, and the build platform may then be lowered by a distance equal to the height of the next layer of build material to be formed. The process may repeat until the build platform is at the bottom of the build chamber, or until no further solidification of build material is needed. At the end of the printing process the build chamber contains a mix of solidified and non-solidified build material.

The dimensions of a build chamber are generally fixed for a given build module of a 3D printing system. However, whilst having a 3D printing system with a relatively large build chamber may enable large, or multiple objects to be formed, in many situations the use of a relatively large build chamber may be inefficient when only relatively small or relatively few objects are to be formed. Similarly, a 3D printing system with a relatively small build chamber may be efficient for forming relatively small or relatively few objects, but may be unsuitable for forming relatively large or relatively many objects.

Examples described herein provide a build module having a variable size build chamber. In some examples such a build module may be configured to provide a build chamber having one or more different sizes or dimensional configurations, for example from a set of available build chamber volume sizes. Also described herein is an example 3D printing system that may determine a size of build chamber to be used for a particular 3D printing operation from a set of available build chamber sizes and may configure a build module to provide the determined build chamber size.

Referring now to FIG. 1, there is shown a build module 100 according to one example. The build module 100 comprises a generally open-topped housing forming a build chamber 102. The build module 100 is formed of surrounding walls 104 and a build platform 106 movable vertically within the build module 100 along an axis, e.g. the z-axis, perpendicular to the plane of the build platform 106. For the purpose of illustration, two of the surrounding walls 104 are shown as transparent, as indicated by the dotted lines. For the purposes of explanation, description of directions, dimensions, axes, and the like, is made with reference to the orientation of the examples illustrated in the accompanying drawings. For example, reference to ‘moving the build platform’ will be understood to be movable in a vertical, or z-axis. In some examples, however, a build module may be oriented differently and the direction of movement will also be different from that described herein.

In FIG. 1 the build platform 106 is illustrated in its lowest, or base, position within the build module 100.

The build platform 106 comprises a first base element 108 and a second base element 110. In one example each of the base elements has the same height H_{BE}. Each of the base elements may be solid or hollow or have any suitable construction and be made from any suitable rigid material, such as a suitable metal, plastic, or the like. The first base element 108 provides a first upper surface 112 and the second base element 110 provides a second upper surface 114. As described in more detail below, the first base element 108 and second base element 110 may form, either individually or in combination, the build platform 106. For the purposes of illustration, the hidden edges of the second base element 110 are shown in dotted lines.

Each of the base elements 108 and 110 are, at least to some extent, independently moveable within the build module 100. In one example, each of the base elements may be independently driven, for example, by a piston, screw mechanism, or the like (not shown). In another example, the base elements may be mechanically coupled such that when the second base element 110 is moved upwards the first base element 108 is also moved upwards at the same time and at the same speed. In this example both of the base elements may thus be moved with only a single drive mechanism. In this example, the coupling of the base elements allows the first base element to be fixed in a position at the top of the build module 100, whilst the second base element remains independently movable. For example, the first base element 108 may be fixed to the top of the build module 100 by any suitable fastening mechanism, such as a mechanical bolt mechanism, electromagnetic elements, and the like.

Irrespective of the movement mechanisms employed, the combination of the independent first and second base elements enables the size of the build chamber to be varied in a quick and simple manner. Thus, as illustrated in FIG. 1, when the build platform 106 is formed of both the first base element 108 and the second base element 110 the effective build platform 106 has a first dimensional configuration, or surface area, W_{BV}×L_{BV}, and the volume of the build chamber 102 is

BV=W_{BV}×L_{BV}×H_{BV}

As illustrated in FIG. 2, the first base element 108 has been positioned and fixed such that its top surface 112 is level with the top of the build module 100, and the second base element 110 remains vertically movable. In this configuration, the build module 100 provides a build platform having a second dimensional configuration, or surface area, W′_{BV}×L′_{BV} and a having a build volume

BV′=W′_{BV}×L′_{BV}×H_{BV}

which is smaller than the build volume BV.

Although the build platform 106 may be positioned at various heights within the build module 100, reference herein to ‘build chamber volume’, or BV, is intended to be understood as the maximum build chamber volume.

The boundary between the base elements 112 and 114 may be sealed, as appropriate, using any suitable sealing mechanism. For instance, if mechanical tolerances are high, in one example no sealing mechanism may be used. If one or both of the base elements 112 and 114 have mechanical tolerances then a sealing mechanism, such as a silicone seal may be provided at the boundary between the two base elements.

Referring now to FIG. 3, there shown a further example of a build module 300. As with the build module 100 of FIG. 1, the build module 300 comprises a generally open-topped housing forming a build chamber 302. The build module 100 is formed of surrounding walls 304 and a build platform indicated generally as 306 movable vertically within the build module 100 along an axis perpendicular to the plane of the build platform 306, i.e. the z-axis. In FIG. 3 the build platform 306 is illustrated in its lowest, or base, position within the build module 300.

The build platform 306 comprises a first base element 308 and a second base element 310. In one example each of the base elements has the same height H_{BE}. Each of the base elements may be solid or hollow or have any suitable construction and be made from any suitable rigid material, such as a suitable metal, plastic, or the like. The first base element 308 provides a first upper surface 312 and the second base element 310 provides a second upper surface 314. As described in more detail below, the first base element 308 and second base element 310 may form, either individually or in combination, the build platform 306.

Each of the base elements 308 and 310 are, at least to some extent, independently moveable within the build module 300. In one example, each of the base elements 308 and 310 may be independently driven, for example, by a piston, screw mechanism, or the like (not shown). In another example, the base elements may be mechanically coupled such that when the second base element 310 is moved upwards the first base element 308 is also moved upwards at the same time and the same speed. In this example both of the base elements 308 and 310 may thus be moved with only a single drive mechanism. In this example, the coupling of the base elements allows one of the base elements to remain in a fixed position at the top of the build module 300, whilst the other one of the base elements remains independently movable.

Irrespective of the movement mechanisms employed, the combination of the independent first and second base elements enables the size of the build chamber to be varied in a quick and simple manner. Thus, as illustrated in FIG. 3, when the build platform 306 is formed of both the first base element 308 and the second base element 310 the effective build platform 306 has planar dimensions W_{BV}×L_{BV}, and the volume of the build chamber 103 is

BV=W_{BV}×L_{BV}×H_{BV}.

As illustrated in FIG. 4, the first base element 308 has been positioned and fixed such that its top surface 312 is level with the top of the build module 300, and the second base element 310 remains vertically movable. In this configuration, the build module 300 provides a build platform having planar dimensions W′_{BV}×L′_{BV} and a having a build volume

BV=W′_{BV}×L′_{BV}×H_{BV}

which is smaller than the build volume BV.

In other examples a build module may be configured in other suitable manners, for example, wherein three or more base elements are provided, or where base elements have other suitable geometrical configurations.

Once a build volume has been set for a build module, the moveable base element, or base elements, may be controlled to enable the build module to be used in the generation of 3D objects. For example, the moveable base element, or base elements, may be controlled initially to a height just below the top of the build module to enable a layer of build material to be formed thereon. After a suitable selective solidification technique has been applied to the formed layer of build material, the moveable base element, or base elements, may be lowered by a predetermined amount to enable a subsequent layer of build material to be formed thereon.

Referring now to FIG. 5, there is illustrated a 3D printer system 500 according to one example. The 3D printer 500 may be any suitable kind of 3D printer 502, such as a powder-based fusing agent and fusing energy type 3D printer, a selective laser sintering (SLS) 3D printer, or the like. The 3D printer 502 comprises a build module 504 in which 3D objects may be generated by the 3D printer 502. In one example the build module 504 is an integrated module of the 3D printer 502, and in another example the build module 504 is a removable build unit that may be moved between the 3D printer 502 and a post-processing module (not shown).

Operation of the 3D printer 502 and build module 504 is controlled by a 3D printer controller 506. The controller 506 comprises a processor, such as a microprocessor or microcontroller, and is coupled to a memory 508. The memory 508 stores processor understandable and executable 3D printer management instructions 510. The instructions 510, when executed by the controller 506, cause the 3D printer controller 506 to control operation of the 3D printer 502 and the build module 504 as described herein, with additional reference to the flow diagram of FIG. 6.

At block 602, the controller 506 determines an appropriate build chamber size to be used. This may be determined, for example, in response to the controller 506 obtaining a 3D print job or other data describing one or multiple 3D objects that are to be generated by the 3D printer 502. For example, the 3D printer 506 may be sent, or may obtain, rasterized slice data of each of the layers of an object model or objects models to be generated. In another example, the 3D printer 506 may be sent, or may obtain, one or multiple object models defining one or multiple 3D objects to be generated.

The determination of the appropriate build chamber size may, for example, be based on determining the smallest configurable build chamber size within the build module 504 based on the size, orientation, arrangement, or the like of the object or objects to be generated.

In another example, the controller 506 may obtain a 3D print job, or other data defining one or more 3D objects to be generated, that includes a chosen build chamber size or is pre-formatted for a chosen build chamber size. This may be achieved, for example, in a similar way to which a 2D printer may receive a print job that indicates the size of media on which the print job is to be printed.

In a further example, the controller 506 may report, or make available, to an external application, such as a computer aided design (CAD) application, a set of available build chamber configurations of the 3D printer 502 to allow the application to choose an appropriate build chamber size.

At block 604, the controller 506 configures the build module 504 to provide a build chamber having the determined size.

For example, taking the build module 300 of FIG. 3, the build module 300 may be configured to provide a build chamber having a build volume

BV=W_{BV}×L_{BV}×H_{BV}

or it may be configured to provide a build chamber having a build volume

BV′=W_{BV}×L′_{BV}×H_{BV}

which is smaller than the build volume BV.

As previously described, configuration of the build chamber may comprise moving one or more of the base elements into a position level with the top of the build module, and fixing them in position such that the one or more base elements that remain moveable provide a build platform for the configured size of build chamber.

At block 606, the controller 506 controls the 3D printer 502 to form successive layers of build material on the build platform, and to selectively solidify portions of each formed layer, thereby generating one or multiple 3D objects in the 3D printer 500.

It will be appreciated that example described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine readable storage storing such a program. Still further, some examples may be conveyed electronically via any medium such as a communication signal carried over a wired or wireless connection.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A build module for a 3D printing system comprising:
a build chamber formed of surrounding walls and a build platform movable within the build chamber, the build platform comprising a first base element and a second base element, the build platform being controllable such that:
in a first configuration the build module provides a build chamber having a first dimensional configuration; and
in a second configuration the build module provides a build chamber having a second dimensional configuration.

2. The build module of claim 1, wherein the dimensional configurations comprise one or more of: a width dimension; a length dimension; a volume; and an area dimension.

3. The build module of claim 1, wherein in the second configuration the first base element is positioned level with the top of the build chamber and wherein the second base element is moveable therein to provide a build chamber having the second dimensional configuration.

4. The build module of claim 1, wherein the first and second base elements have a height equal or substantially equal to the height of the build chamber.

5. The build module of claim 1, wherein the second base element is nested within the first base element.

6. The build module of claim 5, wherein the base elements are concentric.

7. The build module of claim 1, wherein the second base element is immediately adjacent to the first base element.

8. The build module of claim 1, further comprising three or more base elements.

9. A three-dimensional printer, comprising a processor to:
obtain data relating to a 3D object to generate;
determine a build chamber dimensional configuration in which to generate the 3D object;
configure a build chamber to have the determined dimensional configuration; and
to generate the 3D object in the build chamber having the determined dimensional configuration.

10. The three-dimensional printer of claim 9, wherein the processor is to determine a build chamber dimensional configuration from a set of available build chamber dimensional configurations.

11. The three-dimensional printer of claim 9, comprising a build module having a plurality of independently moveable base elements to form a build chamber of different sizes.

12. The three-dimensional printer of claim 9, configured to receive a build module having a plurality of independently movable base elements to form a build chamber of different sizes.

13. The three-dimensional printer of claim 9, wherein the processor is to:
report to an external application the dimensional configurations of a set of available build chamber configurations.

14. A method of operating a three-dimensional printer, comprising:
determining a size of a build chamber in which to generate a three-dimensional object;
configuring a configurable build module to provide a build chamber of the determined size; and
generating the three-dimensional object in the configured build chamber.

15. The method of claim 14, further comprising determining the size of the build chamber from a set of available build chamber sizes.
